(19) United States
(12) Patent Application Publication
(10) Pub. No.: US 2020/0403244 A1
(43) Pub. Date: Dec. 24, 2020

(54) BINDER, COMPOSITION, ELECTRODE MATERIAL, AND METHOD FOR MAKING ELECTRODE MATERIAL

(71) Applicant: Tsinghua University, Beijing (CN)

(72) Inventors: LI WANG, Beijing (CN); XIANG-MING HE, Beijing (CN)

(21) Appl. No.: 17/013,642

(22) Filed: Sep. 6, 2020

Related U.S. Application Data
(63) Continuation of application No. PCT/CN2018/114160, filed on Nov. 6, 2018.

(30) Foreign Application Priority Data
Mar. 9, 2018 (CN) 201810194749.2

(51) Int. Cl. H01M 4/62; H01M 10/0525; H01M 10/054

(52) U.S. Cl. CPC H01M 4/622; H01M 10/054; H01M 10/0525

(57) ABSTRACT

A binder for an electrochemical battery is provided, which is a copolymer including a first repeating unit and a second repeating unit. The first repeating unit has a first side moiety. The second repeating unit has a second side moiety. A first terminal group of the first side moiety is a polar functional group. A second terminal group of the second side moiety is an epoxy group. A composition including the binder and active material particles, an electrode material for the electrochemical battery, and a method for making the electrode material are further provided.

### CROSS-REFERENCE TO RELATED APPLICATIONS

This application claims all benefits accruing under 35 U.S.C. § 119 from China Patent Application No. 2018101947492, filed on Mar. 9, 2018 in the China National Intellectual Property Administration, the content of which is hereby incorporated by reference. This application is a continuation under 35 U.S.C. § 120 of international patent application PCT/CN2018/114160, filed on Nov. 6, 2018, the content of which is also hereby incorporated by reference.

### FIELD

The present disclosure relates to the field of battery, in particular to a binder, a composition, an electrode material, and a method for making the electrode material.

### BACKGROUND

An electrode of an electrochemical battery generally includes a current collector, an active material, a conducting agent, and a binder. The binder is used to guarantee good contact between the active material and the conducting agent, between the active material and the current collector, and between particles of the active material, so as to maintain the structural stability of the entire electrode during charging and discharging cycles to guarantee a smooth electron pathway and a stable electrical performance of the battery in use.

The conventional binder is combined with the active material via a weak force, such as the hydrogen bond and the van der Waals force, which cannot guarantee the structural stability of the electrode and may cause the active material to peel off from the electrode after a long use of the battery.

### SUMMARY

A binder for an electrochemical battery, a composition, an electrode material for the electrochemical battery, and a method for making the electrode material are provided.

The binder for the electrochemical battery is a copolymer including a first repeating unit and a second repeating unit. The first repeating unit has a first side moiety. The second repeating unit has a second side moiety. A first terminal group of the first side moiety is a polar functional group. A second terminal group of the second side moiety is an epoxy group.

In an embodiment, the copolymer is a linear polymer having a formula (I) or (II):

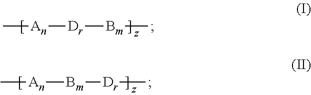

wherein A is the first repeating unit, B is the second repeating unit, D is a third repeating unit, n, m, and z are each independently an integer equal to or larger than 1, and r is an integer equal to or larger than 0.

In an embodiment, the first repeating unit and the second repeating unit are each independently a repeating unit of polyolefin, polyether, polyester, polyamide, polyacetal, polyurethane, polysulfone, or polyphenylene ether ketone.

In an embodiment, the first repeating unit has a formula (III), and the second repeating unit has a formula (IV):

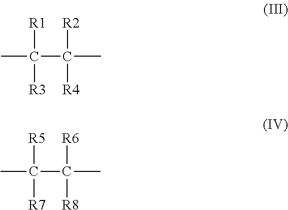

wherein at least one of R1, R2, R3, and R4 is the first side moiety, and the other(s) of R1, R2, R3, and R4 are each independently selected from the group consisting of H, F, Cl, Br, alkyl having 1 to 10 carbon atoms, ethoxyl, aryl, ester group, carbonyl, acylamino group, and any combination thereof; and at least one of R5, R6, R7, and R8 is the second side moiety, and the other(s) of R5, R6, R7, and R8 are each independently selected from the group consisting of H, F, Cl, Br, alkyl having 1 to 10 carbon atoms, ethoxyl, aryl, ester group, carbonyl, acylamino group, and any combination thereof.

In an embodiment, the first side moiety is —X, —R6-X, or

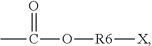

and the second side moiety is —Y, —R9-Y, or

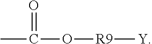

R6 and R9 are each independently unsubstituted or substituted alkyl having 1 to 9 carbon atoms (C1-C9 alkyl), unsubstituted or substituted aryl, or a combination thereof. X is the polar functional group. Y is the epoxy group. At least one hydrogen atom is substituted in the substituted alkyl and the substituted aryl.

In an embodiment, R9 is a straight chain alkyl having 1 to 4 carbon atoms.

In an embodiment, the binder is one of copolymers having the following formulas (V)-(VIII):

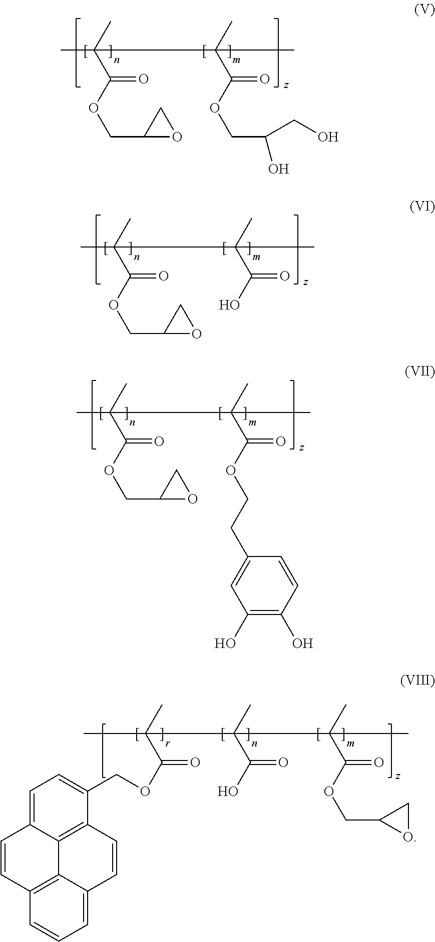

In an embodiment, the polar functional group is selected from the group consisting of carboxyl, hydroxyl, and a combination thereof; the epoxy group is unsubstituted or substituted oxiranyl. At least one hydrogen atom is substituted in the substituted oxiranyl.

In an embodiment, a molar ratio of the first repeating unit to the second repeating unit is about 1:5 to about 7:1.

In an embodiment, the copolymer further includes a third repeating unit having a conjugated Pi bond.

The composition includes the binder for the electrochemical battery and active material particles. A surface of the active material particle has an active group capable of having a nucleophilic addition reaction with the epoxy group.

In an embodiment, the active group is selected from the group consisting of amino group, hydroxyl, carboxyl, cyano group, isocyano group, and any combination thereof.

In an embodiment, a mass ratio of the binder to the active material particles is about 1:3 to about 1:8.

In an embodiment, the electrochemical battery is a lithium ion battery or a sodium ion battery. The active material particles are cathode active material or anode active material.

The electrode material of the electrochemical battery includes a three-dimensional network structure formed from an in-situ cross-linking reaction between the active groups of the surfaces of the active material particles and the epoxy groups of the binder in the composition.

A method for making the electrode material of the electrochemical battery includes: providing the composition and a solvent; mixing the composition and the solvent, thereby obtaining a mixture; and heating the mixture in a vacuum environment to allow the active groups of the surfaces of the active material particles and the epoxy groups of the binder to carry out a cross-linking reaction in situ on the surfaces of the active material particles to obtain a three-dimensional network structure.

In an embodiment, a heating temperature is about 60° C. to about 160° C.

In an embodiment, before heating the mixture in the vacuum environment, the method further includes coating the mixture onto a current collector to form an electrode material layer.

The binder provided in the present disclosure can adhere the active material particles and the current collector together via the polar functional groups of the first side moieties. Moreover, a cross-linking reaction can be carried out in situ on the surfaces of the active material particles by the active groups of the surfaces of the active material particles and the epoxy groups of the second side moieties, so that not only elastic polymer films can be formed on the surfaces of the active material particles, but also a stable three-dimensional network structure can be established. The elastic polymer films can always tightly contact with the active material particles throughout the volume expansion/contraction of the active material particles caused by charging/discharging of the battery, thereby guaranteeing the electrical contact between the active material particles and the structural stability of the electrode. Besides, the elastic polymer films can also stabilize a solid electrolyte interface (SEI) layer formed in the charging/discharging of the battery. In addition, the stable three-dimensional network structure can reduce the change in the volume of the whole electrode caused by volume expansions and contractions of the active material particles, maintain the relative locations between various materials of the electrode, and improve the stability of the structure of the electrode in macroscopic view and microscopic view.

### BRIEF DESCRIPTION OF THE DRAWINGS

FIG. 1 is a schematic view of a three-dimensional network structure formed by active material particles and a binder according to an embodiment of the present disclosure.

FIG. 2 shows cycling curves of lithium ion batteries provided in Example 5, Example 12, and Comparative Example 1 of the present disclosure.

FIG. 3 shows cycling curves of lithium ion batteries provided in Examples 5 to 8 of the present disclosure.

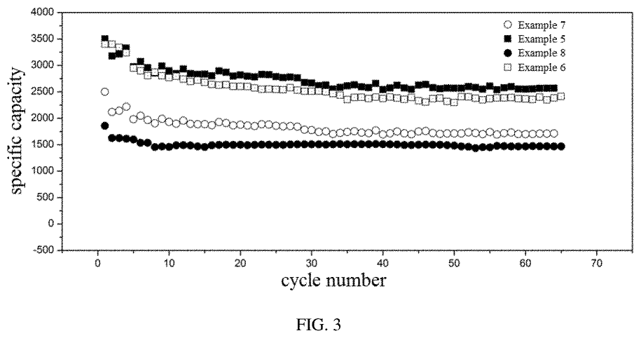

### DETAILED DESCRIPTION

For a clear understanding of the technical features, objects and effects of the present disclosure, specific embodiments of the present disclosure will now be described in detail with reference to the accompanying drawings. It is to be understood that the following description is merely exemplary embodiment of the present disclosure, and is not intended to limit the scope of the present disclosure.

A binder for an electrochemical battery is provided in the present disclosure. The binder is a copolymer including a first repeating unit and a second repeating unit. The first repeating unit has a first side moiety. The first side moiety has a first terminal group which is a polar functional group. The second repeating unit has a second side moiety. The second side moiety has a second terminal group which is an epoxy group (i.e., epoxide).

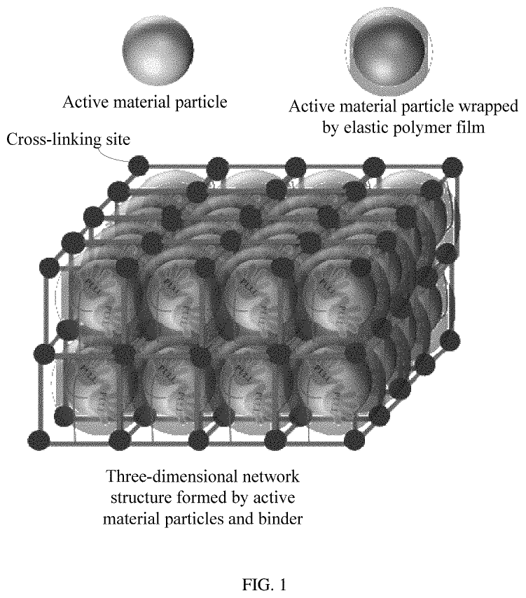

Referring to FIG. 1, the binder provided in the present disclosure can be used to adhere active material particles to a surface of a current collector to form an electrode of the electrochemical battery. An active group capable of reacting with the epoxy group can be provided on a surface of the active material particle. The active material particles and the current collector can be adhered together by the polar functional groups of the first side moieties of the binder. Moreover, a cross-linking reaction can be carried out in situ on the surfaces of the active material particles by the active groups of the surfaces of the active material particles and the epoxy groups of the binder, so that not only an elastic polymer film can be formed on the surface of the active material particle, but also a stable three-dimensional network structure can be established. The elastic polymer film can always tightly contact with the active material particle throughout the volume expansion/contraction of the active material particle caused by charging/discharging of the battery, thereby guaranteeing the electrical contact between the active material particles and the structural stability of the electrode. Besides, the elastic polymer film can also stabilize a solid electrolyte interface (SEI) layer formed in the charging/discharging of the battery. In addition, the stable three-dimensional network structure can reduce the change in the volume of the whole electrode caused by volume expansions and contractions of the active material particles, maintain the relative locations between various materials of the electrode, and improve the stability of the structure of the electrode in macroscopic view and microscopic view.

In an embodiment, the binder is a linear copolymer. The linear copolymer has a relatively high solubility, and can be initially attached to the active material particles via the polar functional groups and then react with the active groups of the surfaces of the active material particles to form the three-dimensional network structure, thereby trapping the active material particles in the three-dimensional network structure.

The copolymer can have a formula (I) or (II):

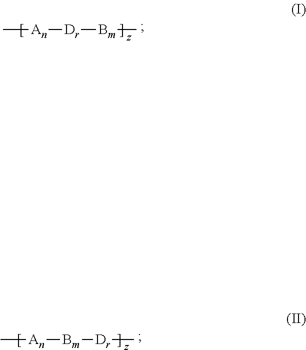

wherein A is the first repeating unit, B is the second repeating unit, D is a third repeating unit, n, m, and z each can be an integer equal to or larger than 1, and r can be an integer equal to or larger than 0.

The first repeating unit, the second repeating unit, and the third repeating unit can each independently be a repeating unit of polyolefin, polyether, polyester, polyamide, polyacetal, polyurethane, polysulfone, and polyphenylene ether ketone. In an embodiment, the first repeating unit, the second repeating unit, and the third repeating unit can each independently be one of the following repeating units:

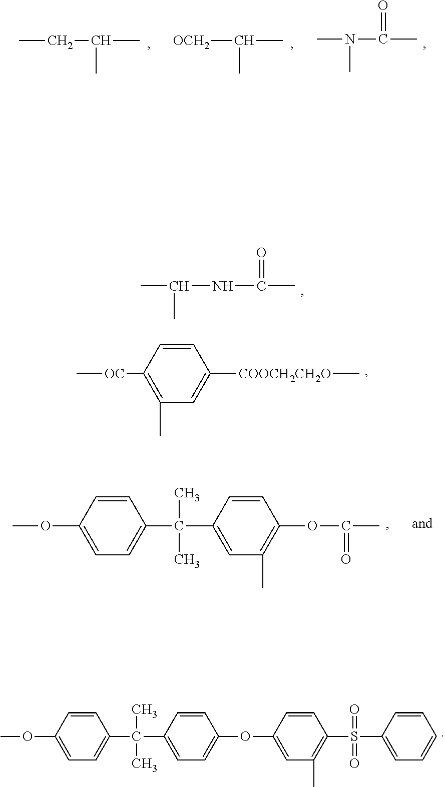

In an embodiment, the first repeating unit has a formula (III) and the second repeating unit has a formula (IV):

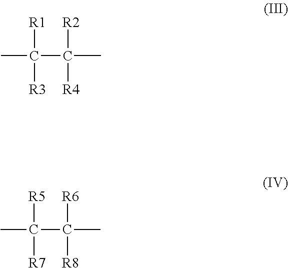

wherein at least one of R1, R2, R3, and R4 is the first side moiety, and the other(s) of R1, R2, R3, and R4 can be each independently selected from the group consisting of H, F, Cl, Br, alkyl having 1 to 10 carbon atoms (C1-C10 alkyl), ethoxyl, aryl, ester group, carbonyl, acylamino group, and any combination thereof; and at least one of R5, R6, R7, and R8 is the second side moiety, and the other(s) of R5, R6, R7, and R8 can be each independently selected from the group consisting of H, F, Cl, Br, alkyl group having 1 to 10 carbon atoms (C1-C10 alkyl), ethoxyl, aryl, ester group, carbonyl, acylamino group, and any combination thereof.

In an embodiment, the first side moiety is —X, —R6-X, or

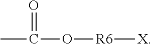

The second side moiety is —Y, —R9-Y, or

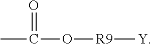

R6 and R9 can each independently be unsubstituted or substituted alkyl having 1 to 9 carbon atoms (C1-C9 alkyl), unsubstituted or substituted aryl, or a combination thereof. For example, at least one of H atoms in the alkyl having 1 to 9 carbon atoms or the aryl can be substituted with halogen, hydroxyl, nitro group, and so on.

X is the polar functional group, and can be selected according to needs as long as the initial adhesion between the active material particles and the initial adhesion between the active material particles and the current collector can be guaranteed. In an embodiment, X is at least one selected from carboxyl, hydroxyl, and a combination thereof. Carboxyl and hydroxyl have relatively strong binding forces to the commonly used current collector, such as copper foil and aluminum foil, of the battery.

The epoxy group can have 2 to 6 carbon atoms. In an embodiment, the epoxy group can be unsubstituted or substituted oxiranyl group which has a relatively high reactivity. At least one of H atoms in the oxiranyl group can be further substituted with halogen, methyl, ethyl, nitro group, and so on.

In an embodiment, the epoxy group is attached to a backbone of the second repeating unit directly or by a straight chain formed by 1 to 5 atoms. For example, R9 can be a straight chain alkyl having 1 to 4 carbon atoms (C1-C4 alkyl). As such, the active material particles can be wrapped closely by the elastic polymer films in-situ grafted onto the surfaces of the active material particles, so as to further guarantee the structural stability of the electrode.

In an embodiment, the first side moiety can be selected from the group consisting of

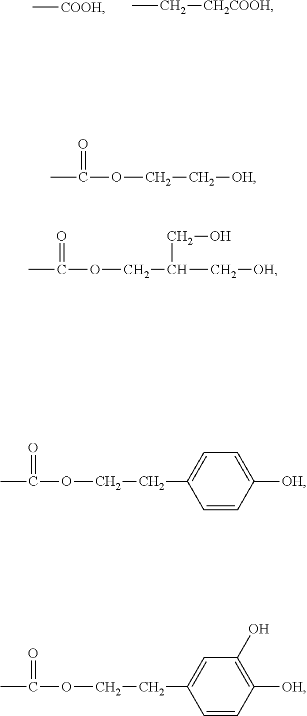

and any combination thereof. The second side moiety can be selected from the group consisting of

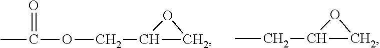

and any combination thereof. At least one of H atoms of alkyls or aryls in any above-mentioned moiety can be further substituted.

The copolymer can further include the third repeating unit D. The third repeating unit D is configured to adjust the performance such as the electrical conductivity, the ionic conductivity, and the mechanical property of the binder. In an embodiment, the third repeating unit D has a conjugated Pi bond to increase the electrical conductivity of the binder. In an embodiment, a pyrene ring, which can provide a good electrical conductivity due to its abundant conjugated Pi bonds, is attached as a third side moiety of the third repeating unit.

In an embodiment, the binder can be one of copolymers having the following formulas (V)-(VIII):

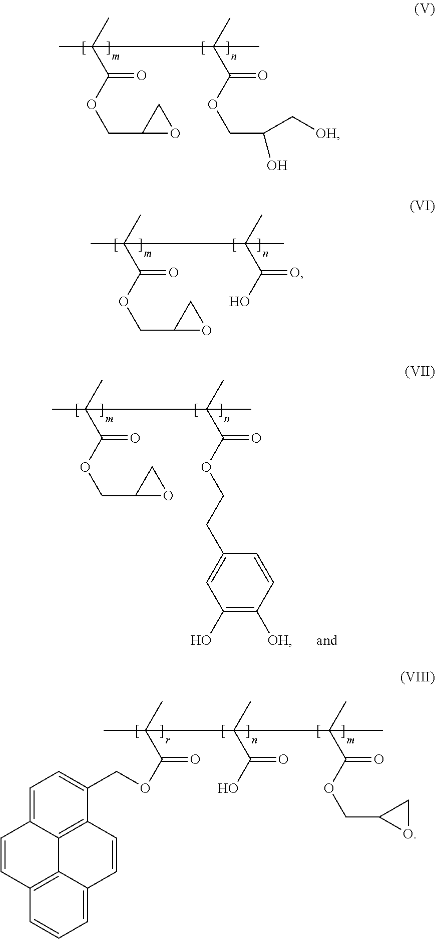

In an embodiment, a molar ratio of the polar functional group to the epoxy group is about 1:5 to about 7:1. This range allows a good adhesion between the binder and the current collector and a good adhesion between the binder and the active material particles to be obtained, thereby guaranteeing the electrical contacts of various materials in the electrode and the structural stability of the electrode. Moreover, this range allows a reasonable interaction, such as a reasonable hydrogen-bond interaction, between the polar functional groups to be achieved. If the hydrogen-bond interaction between the polar functional groups is too strong, the solubility of the binder will be poor and/or the viscosity of the binder will be too high, thereby affecting the processing and the use of the binder.

In an embodiment, the binder can be an alternating copolymer.

A composition is further provided in the present disclosure. The composition includes the binder and the active material particles as described above. An electrode material layer having the composition can be formed onto the current collector, thereby forming the electrode.

A surface of the active material particle has an active group capable of reacting with the epoxy group. In an embodiment, a reactivity between the active group and the epoxy group is higher than a reactivity between the active group and the polar functional group, so that the active group can react with the epoxy group prior to with the polar functional group, and consequently, the three-dimensional network structure can be formed while the polar functional group can be retained to guarantee the adhesion between the composition and the current collector.

In an embodiment, the active group is selected from the group consisting of amino group, hydroxyl, carboxyl, cyano group, isocyano group, and any combination thereof.

In an embodiment, the active group is amino group. The amino group can react with the epoxy group but cannot react with hydroxyl group, a commonly used polar function group, under the normal temperature and normal pressure condition. Therefore, the composition can form the elastic polymer film and the three-dimensional network structure while being adhered to the current collector under the condition of normal temperature and normal pressure.

In an embodiment, the active group is hydroxyl, carboxyl, cyano group, isocyano group, or any combination thereof. The hydroxyl, carboxyl, cyano group, or isocyano group can react with the epoxy group in vacuum by heating. Therefore, the composition can be initially adhered to the current collector by the polar function group under the condition of normal temperature and normal pressure, and then the elastic polymer film and the three-dimensional network structure can be formed through the reaction between the hydroxyl group, the carboxyl group, the cyano group, or the isocyano group with the epoxy group in vacuum by heating.

The active material particle itself can have the active group. Alternatively, the active group can be grafted onto the surface of the active material particle. In an embodiment, the active material particle is a silicon nanoparticle. Hydroxyl group formed on the surface of the silicon nanoparticle due to the exposure of the silicon nanoparticle to the air can act as the active group.

In an embodiment, a mass ratio of the binder to the active material particles is about 1:3 to about 1:8. The composition with this range can provide a good adhesive effect for the active material particles and allow a stable three-dimensional network structure to be formed.

The active material particle can be a cathode active material or an anode active material. The cathode active material can be a lithium transition metal oxide or a sodium transition metal oxide. In an embodiment, the cathode active material is selected from the group consisting of a layer type lithium transition metal oxide, a spinel type lithium transition metal oxide, an olivine type lithium transition metal oxide, and any combination thereof. In an embodiment, the cathode active material is selected from the group consisting of olivine type lithium iron phosphate, layer type lithium cobalt oxide, layer type lithium manganese oxide, spinel type lithium manganese oxide, lithium nickel manganese oxide, lithium cobalt nickel manganese oxide, and any combination thereof. The anode active material is selected from the group consisting of lithium titanate, silicon nanoparticle, graphite, mesophase carbon micro beads (MCMB), acetylene black, carbon miocrobead, carbon fibers, carbon nanotubes, cracked carbon, and any combination thereof.

The composition can further include a conducting agent. The conducting agent can be selected from the group consisting of graphene, carbon nanotubes, carbon fibers, conducting carbon black, porous carbon, cracked carbon, acetylene black, active and conducting graphite, amorphous carbon, and any combination thereof.

It should be understood that the elastic polymer film formed on the surface of the active material particle is a very thin polymer film which has no unfavorable effect on the conduction of the electrons and ions. In addition, the elastic polymer film can be coated on a part or entire of the surface of the active material particle as long as the electrical contact between the active material particles can be tightly combined with each other.

An electrode material for the electrochemical battery is further provided in the present disclosure. The electrode material includes the three-dimensional network structure formed from the in-situ cross-linking reaction between the active groups of the surfaces of the active material particles and the epoxy groups of the binder. The electrode material has high stability, having the active material particles not easy to be detached therefrom. The electrode material can alleviate the volume expansions and extractions of the electrode, and has a long service life.

A method for making the electrode material of the electrochemical battery is further provided in the present disclosure. The method includes:

S1, providing the composition and a solvent;

S2, mixing the composition and the solvent, thereby obtaining a mixture; and

S3, heating the mixture in a vacuum environment to allow the active groups of the surfaces of the active material particles and the epoxy groups of the binder to carry out the cross-linking reaction in situ on the surfaces of the active material particles to obtain the three-dimensional network structure.

In the S1, the solvent can be water, an organic solvent, or a combination thereof.

In the S2, the active material particles and the conducting agent can be initially adhered together through the adhesion effect of the first repeating unit of the binder.

When the active group is the amino group, the elastic polymer film and the three-dimensional network structure can be formed in the S2. In this case, the heating in the vacuum environment in the S3 is only used to remove the solvent. It should be understood that the S3 can be replaced by other drying steps such as naturally drying to remove the solvent.

After the S2, the method can also include a step of coating the mixture onto the surface of the current collector to form an electrode material layer. The polar functional group of the first repeating unit can bind with the current collector so as to adhere the mixture onto the current collector.

The type of the current collector is not limited herein and can be selected according to needs. In an embodiment, the current collector is a copper foil, an aluminum foil, a nickel foil, a foam copper, a carbon collector, and so on.

In the S3, the current collector coated with the mixture can be placed in the vacuum environment and heated.

In the S3, when the active group is hydroxyl, carboxyl, cyano group, isocyano group, or any combination thereof, the epoxy groups of the binder can react with the active groups on the surfaces of the active material particles during the heating in the vacuum environment, thereby forming the elastic polymer films on the surfaces of the active material particles and forming the three-dimensional network structure of the electrode.

The reaction between the epoxy groups of the binder and the active groups of the surfaces of the active material particles can be controlled by controlling the temperature of the vacuum environment. In an embodiment, the vacuum environment is heated to a temperature between 60° C. and 160° C. Within this temperature range, the epoxy groups can react with the active groups while preventing the other groups of the binder from participating in the reaction. The reaction of the other groups may decrease the adhesive force of the binder.

An electrochemical battery is further provided in the present disclosure. The electrochemical battery includes the electrode material as described above. Since the electrode material has a good stability, the electrochemical battery has a good cycling performance. The specific type of the electrochemical battery is not limited and can be, for example, a lithium ion battery or a sodium ion battery.

### Example 1

Glycidyl methacrylate is partially hydrolyzed, thereby obtaining a mixture of unhydrolyzed glycidyl methacrylate and hydrolyzed glycidyl methacrylate. The mixture of the unhydrolyzed glycidyl methacrylate and the hydrolyzed glycidyl methacrylate and a radical initiator, azodiisobutyronitrile (AIBN), are added into an anhydrous organic solvent, tetrahydrofuran, thereby obtaining a reaction liquid. The reaction liquid is heated to 60° C. in a protection atmosphere of argon gas or nitrogen gas to carry out a polymerization reaction. A product of the polymerization reaction is the binder of the formula (V). The preparation scheme of the binder of the formula (V) is shown as below:

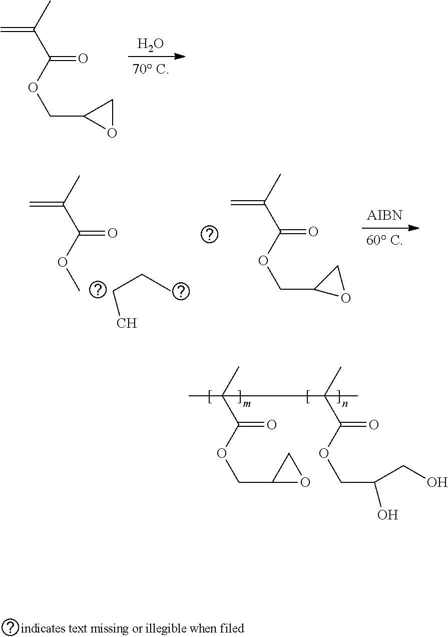

### Example 2

Glycidyl methacrylate, methacrylic acid, and benzoyl peroxide (BPO) are added into an anhydrous organic solvent, tetrahydrofuran, thereby obtaining a reaction liquid. The reaction liquid is heated to 70° C. to carry out a polymerization reaction. A product of the polymerization reaction is the binder of the formula (VI). The preparation scheme of the binder of the formula (VI) is shown as below:

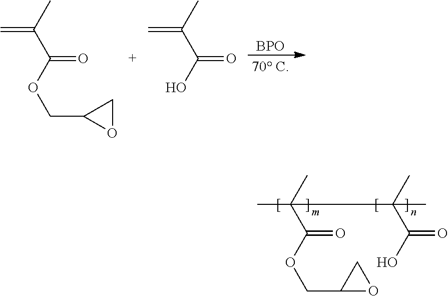

### Example 3

Glycidyl methacrylate and a functionalized benzenediol are added into an anhydrous organic solvent, tetrahydrofuran, thereby obtaining a reaction liquid. The reaction liquid is sequentially subjected to freezing, vacuuming, and unfreezing operations to remove oxygen gas in the reaction liquid. Then a radical initiator, AIBN, is added into the reaction liquid, and the reaction liquid is heated to 60° C. in an inert gas atmosphere to carry out a polymerization reaction. A product of the polymerization reaction is the binder of the formula (VII). The preparation scheme of the binder of the formula (VII) is shown as below:

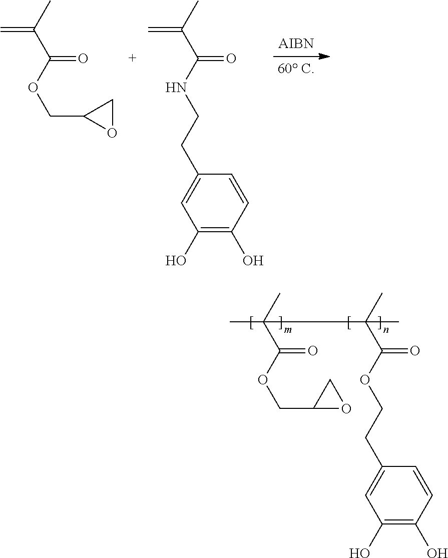

### Example 4

Glycidyl methacrylate, methacrylic acid, and functionalized pyrene (which is electrically conductive due to its Pi bonds) are added into an anhydrous organic solvent, tetrahydrofuran, thereby obtaining a reaction liquid. The reaction liquid is sequentially subjected to freezing, vacuuming, and unfreezing operations to remove oxygen in the reaction liquid. Then a radical initiator, AIBN, is added into the reaction liquid, and the reaction liquid is heated to 60° C. in an nitrogen gas atmosphere to carry out a polymerization reaction for 24 hours. A product of the polymerization reaction is the binder of the formula (VIII) which is electrically conductive. The preparation scheme of the binder of the formula (VIII) is shown as below:

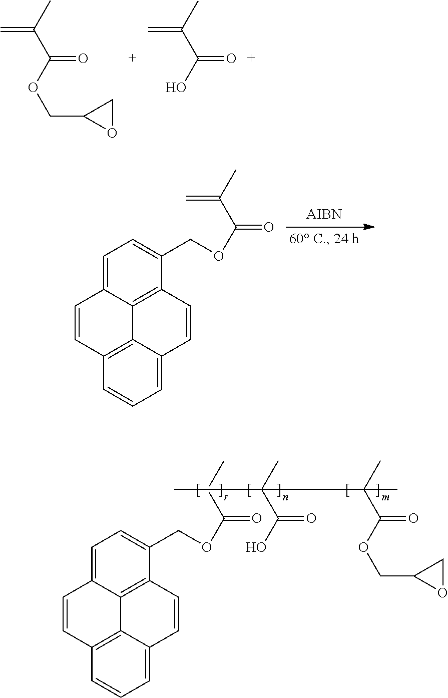

### Example 5

Silicon nanoparticles, conducting carbon black, the binder of the formula (V), and an organic solvent are uniformly mixed, thereby obtaining a slurry. The slurry is uniformly coated on an aluminum foil having a uniform thickness. The aluminum foil coated with the slurry is vacuum heated at 140° C. for 2 hours, thereby obtaining an anode plate. A mass ratio of the silicon nanoparticles to the binder is 8:2. A molar ratio of the first repeating unit to the second repeating unit in the binder is 2:1.

1 mol/L of lithium hexafluorophosphate and 10 wt % of fluoroethylene carbonate (additive) are dissolved in a solvent mixture of ethylene carbonate (EC), diethyl carbonate (DEC), and dimethyl carbonate (DMC) to obtain an electrolyte liquid. A volume ratio of EC:DEC:DMC is 1:1:1. A battery having the anode plate, a metal lithium plate as a counter electrode, Celgard 2400 as a separator, and the electrolyte liquid is assembled, and a charge-discharge performance of the battery is tested.

### Example 6

The Example 6 is substantially the same as the Example 5, except that the molar ratio of the first repeating unit to the second repeating unit of the binder is 1:1.

### Example 7

The Example 7 is substantially the same as the Example 5, except that the molar ratio of the first repeating unit to the second repeating unit of the binder is 1:3.

### Example 8

The Example 8 is substantially the same as the Example 5, except that the molar ratio of the first repeating unit to the second repeating unit of the binder is 1:5.

### Example 9

The Example 9 is substantially the same as the Example 5, except that the mass ratio of the nanoparticles to the binder is 7:3.

### Example 10

The Example 10 is substantially the same as the Example 5, except that the mass ratio of the nanoparticles to the binder is 6:4.

### Example 11

The Example 11 is substantially the same as the Example 5, except that the mass ratio of the nanoparticles to the binder is 5:5.

### Example 12

The Example 12 is substantially the same as the Example 5, except that the binder is represented by the formula (VIII).

### Comparative Example 1

The Comparative Example 1 is substantially the same as the Example 5, except that the binder is polyvinylidene fluoride.

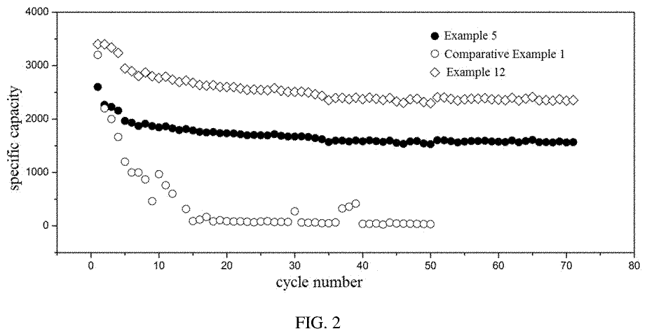

It can be seen form FIG. 2 that the lithium ion batteries in Examples 5 and 12 have better cycling performances and higher specific capacities as compared to the lithium ion battery in the Comparative Example 1, suggesting that the electrode having the binder provided in the present disclosure has a higher stability and a better adhesive effect for the active material particles.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A binder for an electrochemical battery, the binder being a copolymer comprising a first repeating unit and a second repeating unit, wherein the first repeating unit has a first side moiety, the second repeating unit has a second side moiety, a first terminal group of the first side moiety is a polar functional group, and a second terminal group of the second side moiety is an epoxy group.

2. The binder of claim 1, wherein the copolymer is a linear polymer having a formula (I) or (II): 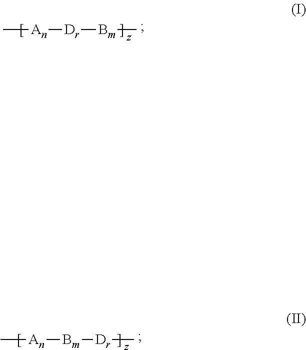
wherein A is the first repeating unit, B is the second repeating unit, D is a third repeating unit, n, m, and z are each independently an integer equal to or larger than 1, and r is an integer equal to or larger than 0.

3. The binder of claim 1, wherein the first repeating unit and the second repeating unit are each independently a repeating unit of polyolefin, polyether, polyester, polyamide, polyacetal, polyurethane, polysulfone, or polyphenylene ether ketone.

4. The binder of claim 1, wherein the first repeating unit has a formula (III), and the second repeating unit has a formula (IV): 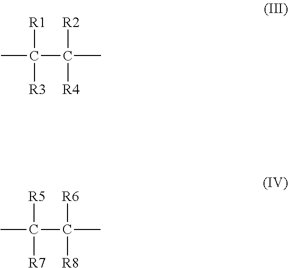
wherein at least one of R1, R2, R3, and R4 is the first side moiety, and the other(s) of R1, R2, R3, and R4 are each independently selected from the group consisting of H, F, Cl, Br, alkyl having 1 to 10 carbon atoms, ethyoxyl, aryl, ester group, carbonyl, acylamino group, and any combination thereof; and at least one of R5, R6, R7, and R8 is the second side moiety, and the other(s) of R5, R6, R7, and R8 are each independently selected from the group consisting of H, F, Cl, Br, alkyl having 1 to 10 carbon atoms, ethyoxyl, aryl, ester group, carbonyl, acylamino group, and any combination thereof.

5. The binder of claim 1, wherein the first side moiety is —X, —R6-X, or 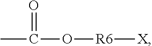
and the second side moiety is —Y, —R9-Y, or 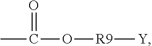
R6 and R9 are each independently unsubstituted or substituted alkyl having 1 to 9 carbon atoms, unsubstituted or substituted aryl, or a combination thereof, X is the polar functional group, and Y is the epoxy group.

6. The binder of claim 5, wherein R9 is a straight chain alkyl having 1 to 4 carbon atoms.

7. The binder of claim 1, wherein the binder is one of copolymers having the following formulas (V)-(VIII):

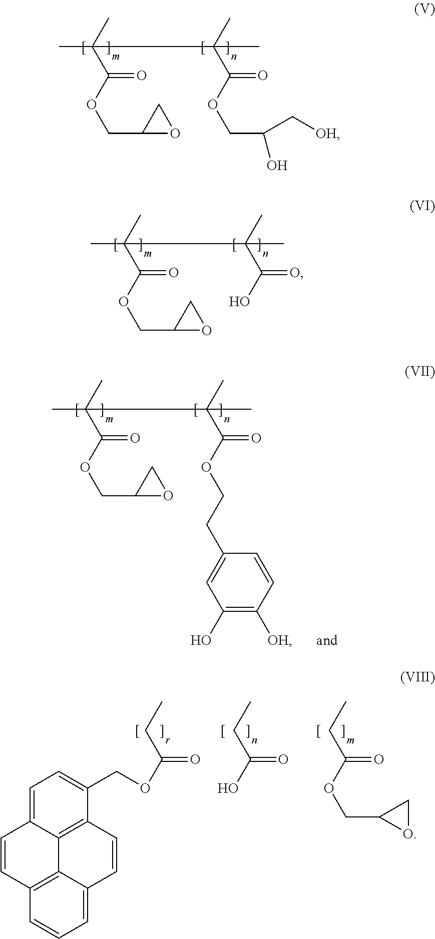

8. The binder of claim 1, wherein the polar functional group is selected from the group consisting of carboxyl, hydroxyl, and a combination thereof.

9. The binder of claim 1, wherein the epoxy group is unsubstituted or substituted oxiranyl group.

10. The binder of claim 1, wherein a molar ratio of the first repeating unit to the second repeating unit is about 1:5 to about 7:1.

11. The binder of claim 1, wherein the copolymer further comprises a third repeating unit having a conjugated Pi bond.

12. A composition, comprising the binder of claim 1 and active material particles, wherein a surface of the active material particle has an active group capable of reacting with the epoxy group.

13. The composition of claim 1, wherein the active group is selected from the group consisting of amino group, hydroxyl, carboxyl, cyano group, isocyano group, and any combination thereof.

14. The composition of claim 1, wherein a mass ratio of the binder to the active material particles is about 1:3 to about 1:8.

15. The composition of claim 1, wherein the active material particles are cathode active material or anode active material of a lithium ion battery, or cathode active material or anode active material of a sodium ion battery.

16. The composition of claim 1, further comprising a conducting agent.

17. The composition of claim 1, where the active material particles are silicon nanoparticles.

18. An electrode material of an electrochemical battery, comprising a three-dimensional network structure formed from an in-situ cross-linking reaction between the active groups of surfaces of the active material particles and the epoxy groups of the binder of claim 1.

19. A method for making an electrode material of an electrochemical battery, the method comprising:
providing the composition of claim 12 and a solvent;
mixing the composition and the solvent, thereby obtaining a mixture; and
heating the mixture in a vacuum environment to allow the active groups of the surfaces of the active material particles and the epoxy groups of the binder to carry out an in-situ cross-linking reaction to obtain a three-dimensional network structure.

20. The method of claim 19, wherein the mixture is heated to a temperature of about 60° C. to about 160° C.
